(19) United States
(12) Patent Application Publication
(10) Pub. No.: US 2015/0341069 A1
(43) Pub. Date: Nov. 26, 2015

(54) CELL PHONE CASE

(71) Applicant: Chien-Ting LIU, Taichung City (TW)

(72) Inventor: Chien-Ting LIU, Taichung City (TW)

(21) Appl. No.: 14/283,068

(22) Filed: May 20, 2014

(51) Int. Cl. H04B 1/3888

(52) U.S. Cl. CPC H04B 1/3888

(57) ABSTRACT

A cell phone case has a shell body, a decoration cover and a positioning device. The shell body is made of metal and has at least one hooking hole. The decoration cover is detachably mounted on the shell body and has at least one hooking tab buckled in the at least one hooking hole. The positioning device is mounted on the shell body, buckled on the decoration cover, and has a sliding base, a pull tab and at least one elastic unit. The sliding base is slidably mounted on the shell body and has a buckle tab buckled on the decoration cover. The pull tab is pivotably mounted on the sliding base. The at least one elastic unit is mounted between the shell body and the sliding base.

### BACKGROUND OF THE INVENTION

1. Field of the Invention

The present invention relates to a cell phone accessory, and more particularly to a cell phone case.

2. Description of Related Art

A cell phone case is mounted on and around a cell phone and can provide a protective effect for the cell phone. Also, the cell phone case can increase an aesthetic appeal for the cell phone.

A conventional cell phone case is made of plastic or leather and is molded integrally. However, the integral structure of the cell phone case has insufficient intensity and is not wear resistant. Furthermore, the appearance of the cell phone case cannot be varied on demand.

### SUMMARY OF THE INVENTION

The main objective of the present invention is to provide a cell phone case to resolve the afore-mentioned problems.

The cell phone case has a shell body, a decoration cover, and a positioning device.

The shell body is made of metal and has at least one hooking hole formed in the shell body.

The decoration cover is detachably mounted on the shell body and has at least one hooking tab mounted on a side of the decoration cover and buckled in the at least one hooking hole.

The positioning device is mounted on the shell body, buckled on the decoration cover, and has a sliding base, a pull tab and at least one elastic unit. The sliding base is slidably mounted on the shell body and has a buckle tab formed on the sliding base and buckled in the decoration cover. The pull tab is pivotably mounted on the sliding base. The at least one elastic unit is mounted between the shell body and the sliding base.

Other objectives, advantages and novel features of the present invention will become more apparent from the following detailed description when taken in conjunction with the accompanying drawings.

### BRIEF DESCRIPTION OF THE DRAWINGS

FIG. 1 is a perspective view of a preferred embodiment of a cell phone case in accordance with the present invention;

FIG. 2 is an exploded perspective view of the cell phone case in FIG. 1;

FIG. 3 is a side view in partial section of the cell phone case in FIG. 1;

FIGS. 4 to 7A are operational side views in partial section of the cell phone case in FIG. 1; and

FIG. 7B is an enlarged side view of the cell phone case in FIG. 7A.

### DETAILED DESCRIPTION OF PREFERRED EMBODIMENT

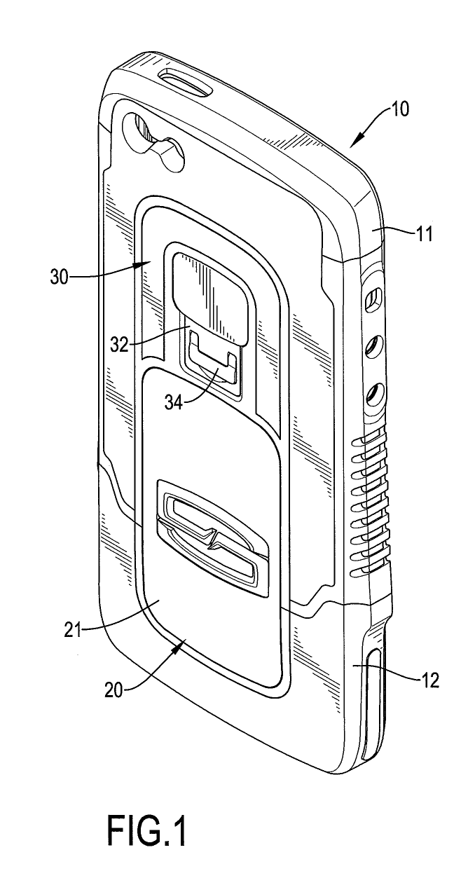

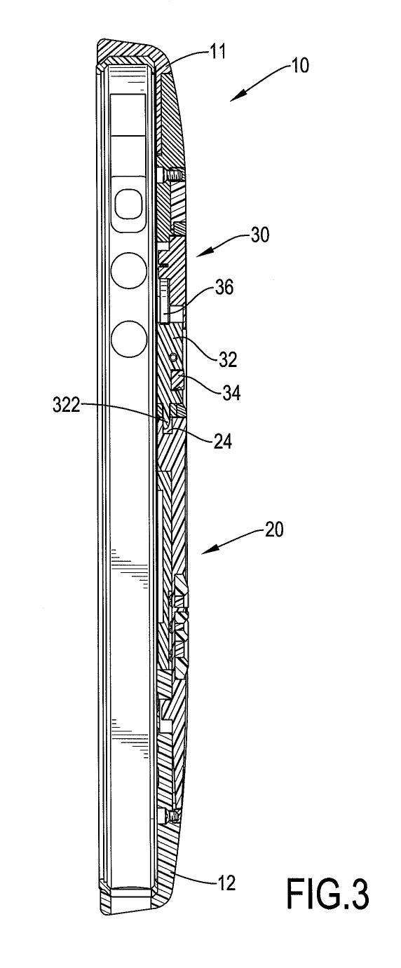

With reference to FIGS. 1 to 3, a preferred embodiment of a cell phone case in accordance with the present invention has a shell body 10, a decoration cover 20 and a positioning device 30.

The shell body 10 may be made of metal and may be formed integrally as s single part. Alternatively, the shell body 10 comprises a main shell part 11 and a secondary shell part 12. The main shell part 11 and the secondary shell part 12 are engaged with each other to form the shell body 10. The main shell part 11 has a first engagement section 111 formed on an end of the main shell part 11. The secondary shell part 12 has a second engagement section 121 formed on an end of the secondary shell part 12. The first engagement section 111 is engaged with the second engagement section 121. The main shell part 11 and the secondary shell part 12 may be made of different materials to meet different use demands. The shell body 10 further has at least one hooking hole 14 formed in the shell body 10.

The decoration cover 20 is detachably mounted on the shell body 10. The decoration cover 20 may be made of metal and has a decoration side 21. A trademark, a figure, or a character can be mounted or printed on the decoration side 21 for identification or aesthetic purposes. The decoration cover 20 further has at least one hooking tab 22 formed on a side of the decoration cover 20 at a position opposite to the decoration side 21 and adjacent to an end of the decoration cover 20. The at least one hooking tab 22 is buckled in the at least one hooking hole 14. The decoration cover 20 further has a buckle trough 24 formed in an end of the decoration cover 20.

The positioning device 30 is mounted on the shell body 10 and is buckled in the buckle trough 24. The positioning device 30 has a sliding base 32, a pull tab 34 and at least one elastic unit 36. The sliding base 32 is slidably mounted on the shell body 10 and has a buckle tab 322 and a pull tab trough 324. The buckle tab 322 is formed on an end of the sliding base 32 and is buckled in the buckle trough 24. The pull tab trough 324 is formed in the sliding base 32. The pull tab 34 is mounted in the pull tab trough 324. The pull tab 34 can be pivoted relative to the sliding base 32. Preferably, each of the pull tab 34 and the pull tab trough 324 may be formed in a U shape. The at least one elastic unit 36 is mounted between the shell body 10 and the sliding base 32.

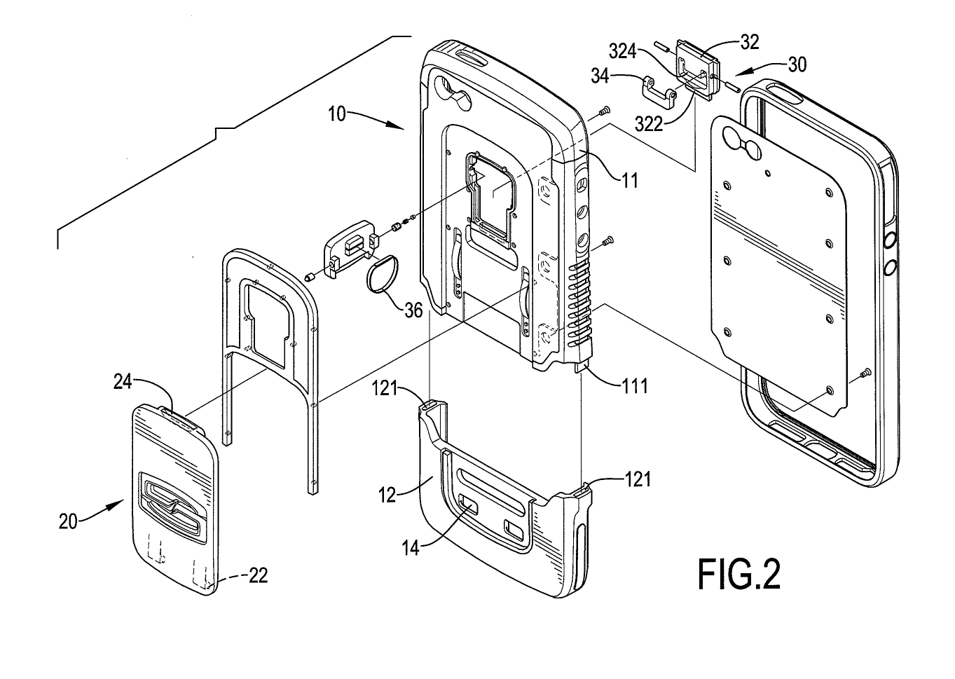

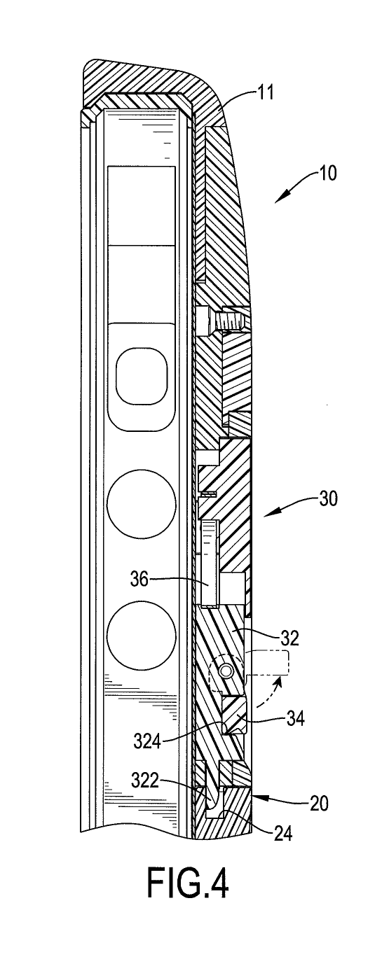

With reference to FIGS. 2 to 5, when the decoration cover 20 is assembled on the shell body 10, the hooking tab 22 is inserted into the at least one hooking hole 14. Then, the pull tab 34 is pivoted relative to the sliding base 32 to be perpendicular to the sliding base 32. Then, the sliding base 32 can be moved relative to the shell body 10 by pushing the pull tab 34. The decoration cover 20 is then put in the shell body 10 to be flush with the shell body 10. Finally, the pull tab 34 is released and the elastic unit 36 pushes the sliding base 32 to slide to an original position relative to the shell body 10 by an elastic force. The buckle tab 322 is inserted into the buckle trough 24 to position the decoration cover 20 relative to the shell body 10.

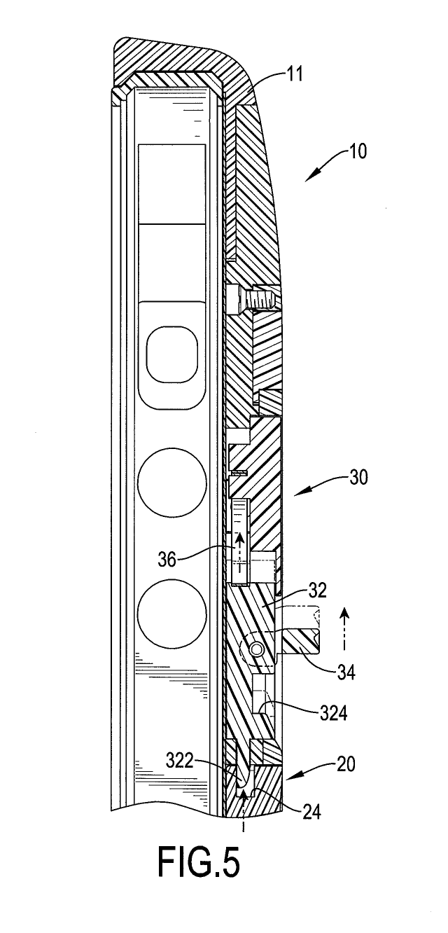

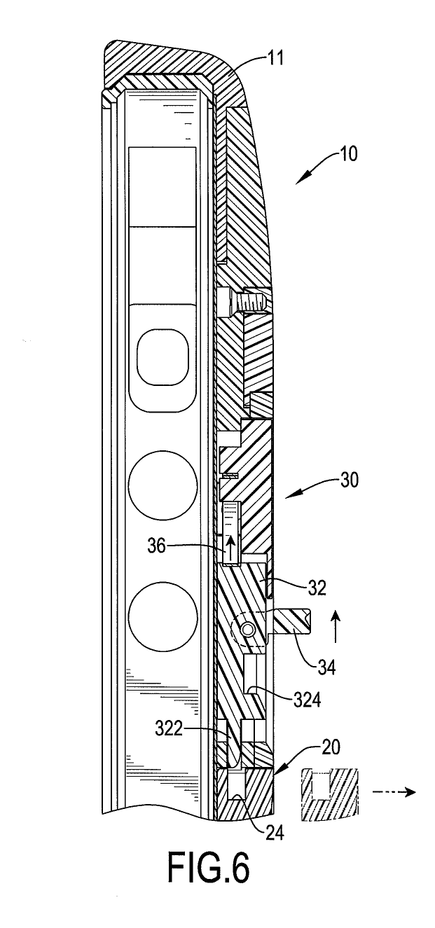

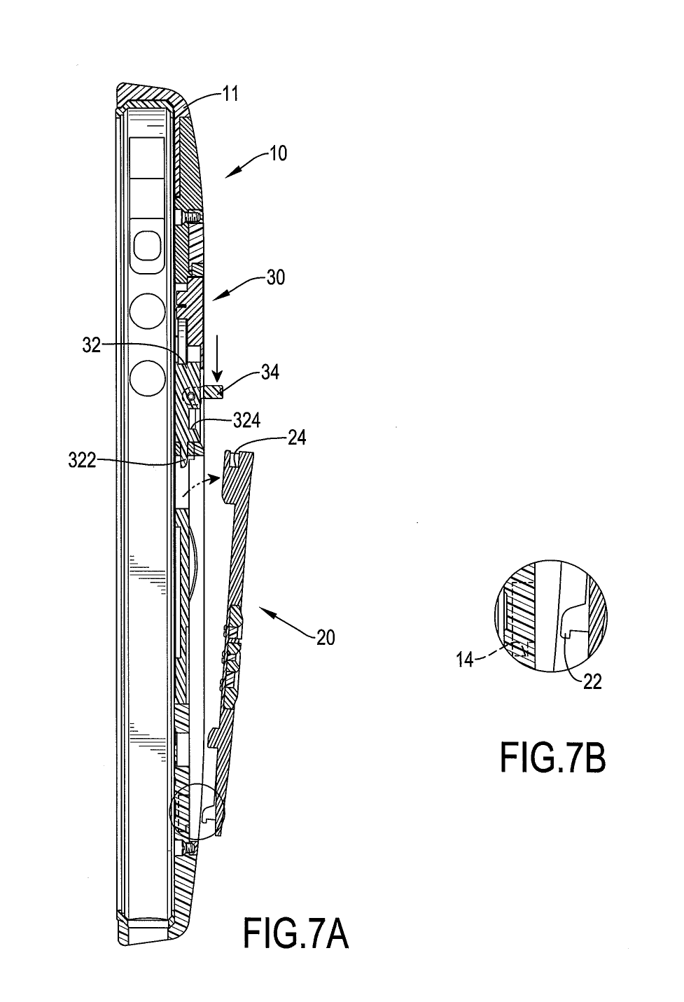

With reference to FIGS. 5 to 7, when the decoration cover 20 is to be replaced, the pull tab 34 is pivoted relative to the sliding base 32 to be perpendicular to the sliding base 32 again. Then, the sliding base 32 is slid relative to the shell body 10 by pulling the pull tab 34, such that the buckle tab 322 can be detached from the buckle trough 24. Then, the decoration cover 20 can be detached from the shell body 10 and can be replaced with another one to meet different user demands.

From the above description, it is noted that the present invention has the following advantages.

The decoration cover 20 can be replaced with another one easily, such that the appearance of the cell phone can be varied. The shell body 10 is made of metal, such that the structure of the shell body 10 is enhanced to improve the intensity of the shell body 10. Therefore, the shell body 10 is wear resistant and is not deformed easily after being used for along time. Furthermore, the cell phone case is assembled by multiple components and can be detached easily. Accordingly, when any one of the components is damaged, the damaged component can be replaced with a new one easily, such that the maintenance costs can be decreased.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A cell phone case having:
a shell body made of metal and having at least one hooking hole formed in the shell body;
a decoration cover detachably mounted on the shell body and having at least one hooking tab mounted on a side of the decoration cover and buckled in the at least one hooking hole; and
a positioning device mounted on the shell body, buckled on the decoration cover, and having
a sliding base slidably mounted on the shell body and having a buckle tab formed on the sliding base and buckled in the decoration cover;
a pull tab pivotably mounted on the sliding base; and
at least one elastic unit mounted between the shell body and the sliding base.

2. The cell phone case as claimed in claim 1, wherein the shell body further has
a main shell part having a first engagement section formed on an end of the main shell part; and
a secondary shell part having a second engagement section formed on an end of the secondary shell part and engaged with the first engagement section.

3. The cell phone case as claimed in claim 1, wherein the sliding base further has a pull tab trough formed in the siding base, wherein the pull tab is pivotally mounted in the pull tab trough.

4. The cell phone case as claimed in claim 2, wherein the sliding base further has a pull tab trough formed in the siding base, wherein the pull tab is pivotally mounted in the pull tab trough.

5. The cell phone case as claimed in claim 3, wherein the pull tab trough and the pull tab are each formed in a U shape.

6. The cell phone case as claimed in claim 4, wherein the pull tab trough and the pull tab are each formed in a U shape.
